(19) United States
(12) Patent Application Publication
(10) Pub. No.: US 2022/0001335 A1
(43) Pub. Date: Jan. 6, 2022

(54) METHOD OF FILTRATION USING POROUS MEMBRANES

(71) Applicant: ASAHI KASEI KABUSHIKI KAISHA, Tokyo (JP)

(72) Inventor: Daisuke OKAMURA, Tokyo (JP)

(73) Assignee: ASAHI KASEI KABUSHIKI KAISHA, Tokyo (JP)

(21) Appl. No.: 17/291,451

(22) PCT Filed: Nov. 8, 2019
(86) PCT No.: PCT/JP2019/043976

§ 371 Date: May 5, 2021

(51) Int. Cl. B01D 65/02; B01D 71/34; B01D 71/36; C02F 1/44; B01D 69/02

(52) U.S. Cl. CPC B01D 65/02; B01D 71/34; B01D 71/36; C02F 2103/08; B01D 69/02; C02F 2303/16; C02F 1/44

(57) ABSTRACT

A method of filtration includes a filtration step in which a liquid to be filtered is filtered through a porous membrane module consisted of a resin having a three-dimensional network structure by external pressure filtration; a cleaning step of cleaning an outer surface of the porous membrane by carrying out backwash of passing a cleaning solution through the porous membrane from an inner surface of the membrane, and air bubbling after the filtration step; and a discharging step of discharging the cleaning solution remaining on the outer surface and inside of the porous membrane after the cleaning step; and in SEM images of a membrane cross section in a membrane thickness direction orthogonal to the inner surface of the porous membrane, a total area of a resin portion having an area of 1 μm² or less is 70% or more relative to a total area of the resin portion.

### FIELD

The present invention relates to a method of filtration using porous membranes. In more detail, the present invention relates to a method of filtration using porous membranes comprising physical cleaning steps.

### BACKGROUND

For tap water treatment for obtaining drinking water and industrial water from natural water sources such as river water, lake and marsh water, underground water, etc., which are suspended water, and for sewage treatment for treating domestic wastewater such as sewage, etc., to produce reclaimed water that is dischargeable as clarified water, solid-liquid separation operation (clarification operation) for removing suspended matters is essential. The main clarification operation required is, in regard to the tap water treatment, removal of suspended substances (clay, colloid, bacteria, etc.) derived from natural water source water as suspended water, and regarding the sewage treatment, removal of suspended matters in sewage and suspended matters (sludge, etc.) in treated water that is biologically treated (secondary-treated) with an activated sludge, etc.

Conventionally, these clarification operations have been carried out mainly by a precipitation method, a sand filtration method, and a coagulation sedimentation plus sand filtration method, and recently, a membrane filtration method has been widespread. The advantages of the membrane filtration method are as follows: (1) clarification level of the obtained water quality is high and stable (safety of the obtained water is high), (2) installation space of a filtration apparatus can be small, (3) automatic operation is easy, etc. For example, in tap water treatment, the membrane filtration method is used, as a substitute for the coagulation sedimentation plus sand filtration method, or as a means, etc., for further improving water quality of treated water subjected to the coagulation sedimentation plus sand filtration by installing at a rear stage of the coagulation sedimentation plus sand filtration process. Also, regarding the sewage treatment, use of the membrane filtration method is investigated for separation, etc., of a sludge from sewage secondary treated water. In these clarification operations by membrane filtration, a hollow fiber-shaped ultrafiltration membrane or microfiltration membrane (pore diameter in a range of several nm to several hundred nm) is mainly used. As described above, clarification by the membrane filtration method has many advantages that conventional precipitation methods and sand filtration methods do not have, thus, spread to a tap water treatment and a sewage treatment is progressing as a substitute technology or complementary technology of conventional methods, and among these membranes, organic membranes using resins are frequently used (for example, refer to Patent Literature 1).

### CITATION LIST

### Patent Literature

### [PTL 1] Japanese Unexamined Patent Application Publication No. 2011-168741

### SUMMARY

### Technical Problem

As described above, although an organic membrane consisted of a resin is frequently used as a porous membrane, when fabricating a porous filtration membrane with a resin material, difference in microstructure of a material constituting the membrane comes out if a membrane fabrication method is different. Normally, if filtration operation is continued, the membrane will be clogged, and therefore the operation of the filtration method using the porous filtration membrane accompanies a cleaning process. However, when there is a difference in the microstructure of the material constituting the porous filtration membrane, even though the membrane consisted of the same material is used, damage of the membrane by a physical cleaning of the membrane surface differs, which gives rise to a problem of affecting filtration performance and life thereof.

In view of such an issue, a problem to be solved by the present invention is to provide a filtration method excellent in filtration performance and cleaning efficiency and having a long life, in a filtration method using a porous filtration membrane comprising a physical cleaning step.

### Solution to Problem

If a filtration operation is continued, a membrane is always clogged, and physical cleaning using air bubbling, etc., triggers deterioration in strength of the membrane. The present inventors have carried out much diligent experimentation with the aim of solving the problems described above. As a result, the present inventors have unexpectedly found that deterioration of the membrane can be minimized by using a membrane having favorable percolativity between fine pores of the membrane and the membrane can be efficiently cleaned without impairing filtration performance and has a long service life by selecting a prescribed physical cleaning method, and thus have come to solve the aforementioned problems.

Namely, the present invention is as follows:

[1] A method of filtration, comprising steps below:

a filtration step in which a liquid to be filtered is filtered through a porous membrane module consisted of a resin having a three-dimensional network structure by external pressure filtration;

a cleaning step of cleaning an outer surface of the porous membrane by carrying out backwash of passing a cleaning solution through the porous membrane from an inner surface of the membrane, and air bubbling after the filtration step; and

a discharging step of discharging the cleaning solution remaining on the outer surface and inside of the porous membrane after the cleaning step; and

in SEM images of a membrane cross section in a membrane thickness direction orthogonal to the inner surface of the porous membrane, a total area of a resin portion having an area of 1 μm² or less is 70% or more relative to a total area of the resin portion in each region of a total of four visual fields consisting of a visual field including the inner surface, a visual field including the outer surface of the membrane, and two fields of vision photographed at equal intervals between the these visual fields.

[2] A method of filtration, comprising steps below:

a filtration step in which a liquid to be filtered is filtered through a porous membrane module consisted of a resin having a three-dimensional network structure by external pressure filtration;

a cleaning step of cleaning an outer surface of the porous membrane by carrying out backwash of passing a cleaning solution through the porous membrane from an inner surface of the membrane, and air bubbling after the filtration step; and

a discharging step of discharging the cleaning solution remaining on the outer surface and inside of the porous membrane after the cleaning step; and

in SEM images of a membrane cross section in a membrane thickness direction orthogonal to the inner surface of the porous membrane, a total area of a resin portion having an area of 10 μm² or more is 15% or less relative to a total area of the resin portion in each region of a total of four visual fields consisting of a visual field including the inner surface, a visual field including the outer surface of the membrane, and two fields of vision photographed at equal intervals between the these visual fields.

[3] A method of filtration, comprising steps below:

a filtration step in which a liquid to be filtered is filtered through a porous membrane module consisted of a resin having a three-dimensional network structure by external pressure filtration;

a cleaning step of cleaning an outer surface of the porous membrane by carrying out backwash of passing a cleaning solution through the porous membrane from an inner surface of the membrane, and air bubbling after the filtration step; and

a discharging step of discharging the cleaning solution remaining on the outer surface and inside of the porous membrane after the cleaning step; and

in SEM images of a membrane cross section in a membrane thickness direction orthogonal to the inner surface of the porous membrane, a total area of a resin portion having an area of 1 μm² or less is 70% or more relative to a total area of the resin portion and a total area of a resin portion having an area of 10 μm² or more is 15% or less relative to the total area of the resin portion in each region of a total of four visual fields consisting of a visual field including the inner surface, a visual field including the outer surface of the membrane, and two fields of vision photographed at equal intervals between the these visual fields.

[4] The method of filtration according to any one of [1] to [3], wherein the porous membrane module has an effective membrane length of 1.5 m or more.
[5] The method of filtration according to any one of [1] to [4], wherein the cleaning step is carried out after a water permeability of the porous membrane module in the filtration step is decreased to 70% or less of an initial value.
[6] The method of filtration according to [5], wherein a chemical solution cleaning step is carried out when a water permeability of the porous membrane module in the filtration step is reduced to 70% or less of an initial value.
[7] The method of filtration according to [6], wherein the chemical solution cleaning step is carried out before or after the cleaning step.
[8] The method of filtration according to [6], wherein the chemical solution cleaning step is the cleaning step.
[9] The method of filtration according to [5], wherein the cleaning step is carried out after a water permeability of the porous membrane module in the filtration step is reduced to 50% or less of an initial value.
[10] The method of filtration according to [5] or [9], wherein a water permeability of a porous membrane module at nth cycle is 80% or more of a water permeability at n−1th cycle when a series of the filtration step, the cleaning step, and the discharging step is one cycle.
[11] The method of filtration according to [6], wherein a water permeability of the porous membrane module after the chemical solution cleaning step after an elapse of 20,000 cycles is 80% or more of an initial value.
[12] The method of filtration according to any one of [1] to [11], wherein a flux of backwash in the cleaning step is 1 to 3 times a flux in the filtration step.
[13] The method of filtration according to [6] or [11], wherein a chemical solution cleaning step is carried out at a specific number of times, and the chemical solution contains an aqueous sodium hydroxide solution.
[14] The method of filtration according to any one of claims [6], [11] and [13], wherein a chemical solution cleaning step is carried out at a specific number of times, and the chemical solution contains an oxidizing agent.
[15] The method of filtration according to any one of [1] to [14], wherein a cleaning step at a specific number of times is a chemical solution cleaning step, and an oxidizing agent is added to a backwash solution upon backwash in the chemical solution cleaning step.
[16] The method of filtration according to [14] or [15], wherein a standard electrode potential of the oxidizing agent is 1 V or more.
[17] The method of filtration according to [16], wherein a standard electrode potential of the oxidizing agent is 1.8 V or more.
[18] The method of filtration according to any one of [1] to [17], wherein in the discharging step, a cleaning solution is discharged from a lower part of the module.
[19] The method of filtration according to [18], wherein discharge of a cleaning solution from a lower part of the module is carried out by pushing pressurized air from a side nozzle of the module.
[20] The method of filtration according to [19], wherein a pressure of the pressurized air is 0.2 MPa or less.
[21] The method of filtration according to [20], wherein a module weight after the discharging step is three times or less an initial dry weight of the module.
[22] The method of filtration according to any one of [1] to [21], wherein the porous membrane has a breakage ratio of 0.5% or less after an elapse of 20,000 cycles.
[23] The method of filtration according to any one of [1] to [22], wherein a resin constituting the porous membrane is a thermoplastic resin.
[24] The method of filtration according to [23], wherein the thermoplastic resin is a fluororesin.
[25] The method of filtration according to [24], wherein the fluororesin is at least one resin selected from a group consisting of a vinylidene fluoride resin (PVDF), a chlorotrifluoroethylene resin, a tetrafluoroethylene resin, an ethylene-tetrafluoroethylene copolymer (ETFE), an ethylene-monochlorotrifluoroethylene copolymer (ECTFE), a hexafluoropropylene resin and any mixture of these resins.

### Advantageous Effects of Invention

The method of filtration of the present invention enables to minimize membrane deterioration by using the membrane having high percolativity between fine pores in the cross sectional microporous structure and it can be efficiently cleaned without impairing the filtration performance and have a long service life by selecting a prescribed physical cleaning method.

Upon carrying out a cycle of “filtration, cleaning, and discharging”, if a membrane module is still relatively new, for example, when the cycle is once to several thousand times, the water permeability can be recovered to a level comparable to that of the water permeability recovered upon the previous physical cleaning (cycle) such as backwash or air scrubbing (air bubbling), etc. However, if the physical cleaning cycle exceeds several thousand times, due to physical or chemical deterioration of the membrane, the water permeability recovered by the physical cleaning such as backwash or air scrubbing (air bubbling), etc., may be only about 50 to 75% of the water permeability recovered upon the previous physical cleaning (cycle).

Since the membrane used in the filtration method of the present invention has favorable percolativity inside the membrane, even when the physical cleaning cycle as described above exceeds several thousand times, the water permeability recovered by the physical cleaning (only) can be 80% or more of the water permeability recovered upon the previous cleaning, and therefore, when the water permeability becomes, for example, 50% or less of an initial water permeability and carrying out cleaning using a chemical solution in addition to the physical cleaning alone, it is possible to reduce the frequency of carrying out the cleaning using the chemical solution.

Thus, when the method of filtration of the present invention is used, damage to the membrane due to chemical cleaning, water and process time required for rinsing after using the chemical solution, and the environmental impact of discarding the water containing the chemical solution, can be reduced.

### BRIEF DESCRIPTION OF DRAWINGS

FIG. 1 is an example of an SEM image of a cross section of the porous membrane used in the method of filtration of the present embodiment (a black portion indicates a resin and a white portion indicates a fine pore (open pore)).

FIG. 2 is a histogram illustrating a total proportion (%) of a total area of a resin portion having a prescribed area relative to a total area of the resin portion in each region (1 in circle to 4 in circle) of a total of four visual fields consisting of a visual field including the inner surface, a visual field including the outer surface of the membrane, and two fields of vision between the these visual fields, that are photographed at equal intervals, in SEM images of a membrane cross section in a membrane thickness direction orthogonal to the inner surface of the porous membrane used in Example 1.

FIG. 3 is a histogram illustrating a total proportion (%) of a total area of a resin portion having a prescribed area relative to a total area of the resin portion in each region (1 in circle to 4 in circle) of a total of four visual fields consisting of a visual field including the inner surface, a visual field including the outer surface of the membrane, and two fields of vision between the these visual fields, that are photographed at equal intervals, in SEM images of a membrane cross section in a membrane thickness direction orthogonal to the inner surface of the porous membrane used in Example 2.

FIG. 4 is a histogram illustrating a total proportion (%) of a total area of a resin portion having a prescribed area relative to a total area of the resin portion in each region (1 in circle to 4 in circle) of a total of four visual fields consisting of a visual field including the inner surface, a visual field including the outer surface of the membrane, and two fields of vision between the these visual fields, that are photographed at equal intervals, in SEM images of a membrane cross section in a membrane thickness direction orthogonal to the inner surface of the porous membrane used in Example 3.

FIG. 5 is a histogram illustrating a total proportion (%) of a total area of a resin portion having a prescribed area relative to a total area of the resin portion in each region (1 in circle to 4 in circle) of a total of four visual fields consisting of a visual field including the inner surface, a visual field including the outer surface of the membrane, and two fields of vision between the these visual fields, that are photographed at equal intervals, in SEM images of a membrane cross section in a membrane thickness direction orthogonal to the inner surface of the porous membrane used in Comparative Example 2.

FIG. 6 is a flowchart illustrating an example of a filtration system including an ultrafiltration (UF) means, a reverse osmosis (RO) means, a backwash means, and an air bubbling means, using the porous membrane.

### DESCRIPTION OF EMBODIMENTS

Embodiments for carrying out the invention (hereunder often referred to as “the present embodiment”) will now be explained in detail below. It is to be understood, however, that the present invention is not limited to the following embodiments.

An aspect of the present embodiment is a method of filtration, comprising:

a filtration step in which a liquid to be filtered is filtered through a porous membrane module consisted of a resin having a three-dimensional network structure by external pressure filtration;

a cleaning step of cleaning an outer surface of the porous membrane by carrying out backwash of passing a cleaning solution through the porous membrane from an inner surface of the membrane, and air bubbling after the filtration step; and

a discharging step of discharging the cleaning solution remaining on the outer surface and inside of the porous membrane after the cleaning step; and

in SEM images of a membrane cross section in a membrane thickness direction orthogonal to the inner surface of the porous membrane, a total area of a resin portion having an area of 1 μm² or less is 70% or more relative to a total area of the resin portion, and/or a total area of the resin portion having an area of 10 μm² or more is 15% or less relative to a total area of the resin portion, in each region of a total of four visual fields consisting of a visual field including the inner surface, a visual field including the outer surface of the membrane, and two fields of vision photographed at equal intervals between the these visual fields.

### <Filtration Method>

The method of filtration of the present embodiment comprises a filtration step in which a liquid to be filtered is filtered through a porous membrane (for example, a porous hollow fiber membrane) consisted of a resin, a cleaning step of cleaning the outer side of the porous membrane after the filtration step, and further a discharging step for discharging the cleaning solution remaining on the outer surface and inside of the porous membrane. The starting cue of the cleaning step after the filtration step is given after the filtration step reaches completion time thereof, wherein the filtration step and the cleaning step are operated by time or given when the filtration pressure of the filtration step reaches a certain value. In the former, the membrane can always be maintained with cleanliness since it can be periodically cleaned, and in the latter method it can be efficiently cleaned. In these cases, the cleaning is preferably carried out when the water permeability obtained by dividing the filtration flux by the filtration pressure is reduced to 70%, and more preferably, the cleaning is carried out when the water permeability is reduced to 50%.

In the present description, the term “inner surface of the porous membrane” refers to the surface on the hollow portion side in the case of a hollow fiber membrane, and the term “outer surface of the porous membrane” refers to the outer surface of a hollow fiber in the case of the hollow fiber membrane.

In the present description, the term “inside of the porous membrane” refers to a membrane thickness portion where a large number of fine pores are formed.

The filtration step in the filtration method of the present embodiment is so-called external pressure type filtration step of, for example, supplying a liquid to be treated containing substances to be filtered to the outer surface of a porous hollow fiber membrane, filtering it through a membrane thickness portion of the porous hollow fiber membrane, and taking out as a filtrate oozed from the inner surface of the porous hollow fiber membrane.

In the present description, the “substance to be filtered” means a substance, etc., contained in water to be treated that is supplied to the porous membrane in the filtration step, removed by filtration, and separated from the filtrate.

The cleaning solution used in the cleaning step of the present embodiment may contain an oxygen-based oxidizing agent having a standard electrode potential of 1 V or more, preferably an aqueous solution using Fenton's reaction reagent containing at least one species selected from the group consisting of ozone, hydrogen peroxide, percarbonate, and persulfate. The oxygen-based oxidant having a standard electrode potential of 1 V or more is more preferably an oxygen-based oxidant having a voltage of 1.5 V or more, furthermore preferably an oxygen-based oxidant having a voltage of 1.7 V or more, and even more preferably an oxygen-based oxidant having a voltage of 1.8 V or more. The higher the standard electrode potential is, the stronger the oxidizing power is, and more likely it is to decompose contaminants attached to the membrane. Fenton's reagent is a solution of hydrogen peroxide and an iron catalyst and is generally used for oxidation of pollutants and industrial wastewater. The Fenton's reagent can also be used to decompose organic compounds such as trichlorethylene (TCE), tetrachloroethylene (PCE), etc. An Iron (II) ion is oxidized to an iron (III) ion by hydrogen peroxide to produce a hydroxyl radical and a hydroxide ion (Fe²⁺+H₂O₂→Fe³⁺+OH.+OH⁻). Next, the iron (III) ion is reduced to an iron (II) ion, which forms a hydroperoxide radical and a proton by an oxygen-based oxidant (Fe³⁺+H₂O₂→Fe²⁺+OOH.+H⁺). The standard electrode potential of the oxidation-reduction reaction can be measured by cyclic voltammetry, etc., as a potential difference from the standard electrode (reference electrode). For example, the standard electrode potentials for the following reactions are the following numerical values.

H₂O₂+2H⁺+2e⁻←→2H₂O . . . +1.77V

O₃+2H⁺+2e⁻←→O₂+H₂O . . . +2.08V

Examples of the oxygen-based oxidant include hydrogen peroxide, ozone, percarbonate, persulfate, metal peroxides such as sodium peroxide, etc., organic peroxides such as peracetic acid, etc. The aqueous solution using Fenton's reagent preferably contains 0.005% by weight or more of iron (II) ions and 0.5% by weight or more of an oxygen-based oxidant and has a pH of 7 or less, and it more preferably contains 0.005% by weight or more of iron (II) ions and 1.0% by weight or more of an oxygen-based oxidant and has a pH of 4 or less. Moreover, it is preferable to adjust a pH with weak acids such as organic acid, etc. By using these aqueous solutions using Fenton's reagent, for example, when a liquid to be treated is seawater, a high cleaning effect can be obtained.

The liquid to be treated in the filtration step of the method of filtration of the present embodiment is not particularly limited, and examples thereof include not only seawater but also suspended water, process liquid, etc. For example, the method of filtration of the present embodiment can be employed for the water purification method comprising a step of filtering suspended water.

In the present description, the term “suspended water” refers to natural water, domestic wastewater (wastewater), treated water thereof, etc. Examples of natural water include river water, lake and marsh water, underground water, and seawater. Treated water obtained by subjecting these natural waters to sedimentation treatment, sand filtration treatment, coagulation sedimentation plus sand filtration treatment, ozone treatment, activated carbon treatment, etc., is also included in the suspended water. An example of domestic wastewater is sewage water. Primary treated water of sewage water subjected to screen filtration and sedimentation treatment, secondary treated water of sewage water subjected to biological treatment, and further tertiary treated (highly treated) water such as coagulation sedimentation plus sand filtration, activated carbon treatment, ozone treatment, etc., are also included in the suspended water. These suspended waters may contain turbid substances (such as humus colloid, organic colloid, clay, bacteria, etc.) consisted of fine organic substances, inorganic substances and organic-inorganic mixtures with a size of not larger than μm order, and polymer substances derived from bacteria and algae.

Suspended water quality can generally be defined by turbidity and/or concentration of organic matters, which are typical indices of water quality. According to the turbidity (not an instantaneous turbidity, but an average turbidity), water quality can roughly be classified into low turbid water with a turbidity of less than 1, medium turbid water with a turbidity of not less than 1 to less than 10, high turbid water with a turbidity of not less than 10 but less than 50, ultra-high turbid water with a turbidity of not less than 50, etc. Moreover, according to a concentration of organic matters (total organic carbon (TOC): mg/L) (also not an instantaneous value but an average value), water quality can roughly be classified into low TOC water with a TOC of less than 1, medium TOC water with a TOC of 1 or more and less than 4, high TOC water with a TOC of 4 or more and less than 8, ultra-high TOC water with a TOC of 8 or more, etc. Basically, water with higher turbidity or TOC is more likely to clog a filtration membrane and thus the effects of using the porous filtration membrane become greater for the water with higher turbidity or TOC.

A process liquid refers to a liquid to be separated when separating valuables from non-valuables in foods, pharmaceuticals, and semiconductor manufacturing. In food production, for example, when liquors such as sake and wine, and yeast are separated, the method of filtration of the present embodiment can be used. In the manufacture of pharmaceuticals, for example, the method of filtration of the present embodiment can be used for sterilization, etc., when purifying proteins. Moreover, in semiconductor manufacturing, for example, the method of filtration of the present embodiment can be used to separate abrasives and water from polishing wastewater.

The structures, materials, and methods of manufacturing the porous membrane used in the filtration method of the present embodiment will be described in detail below.

### <Porous Membrane>

A porous membrane used in the filtration method of the present embodiment has either a total area of a resin portion having an area of 1 μm² or less of 70% or more relative to a total area of the resin portion in each region of a total of four visual fields consisting of a visual field including the inner surface, a visual field including the outer surface of the membrane, and two fields of vision photographed at equal intervals between the these visual fields, in SEM images of a membrane cross section in a membrane thickness direction orthogonal to the inner surface of the porous membrane; a total area of a resin portion having an area of 10 μm² or more of 15% or less relative to a total area of the resin portion in the same each region; or a total area of a resin portion having an area of 1 μm² or less of 70% or more relative to the total area of the resin portion and a total area of a resin portion having an area of 10 μm² or more of 15% or less relative to the total area of the resin portion in the same each region. The porous membrane preferably has, in the same each region, a total area of a resin portion having an area of 1 μm² or less of 70% or more relative to the total area of the resin portion, and a total area of a resin portion having an area of more than 1 μm² to less than 10 μm² of 15% or less relative to the total area of the resin portion, as well as a total area of a resin portion having an area of 10 μm² or more of 15% or less relative to the total area of the resin portion.

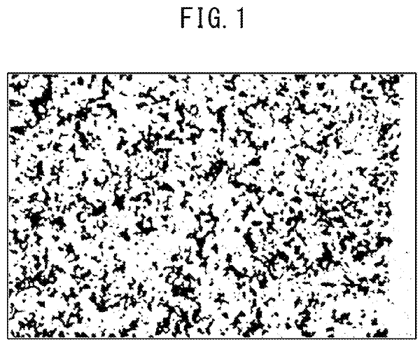

FIG. 1 is an example of an SEM image of a cross section of the porous membrane used in the method of filtration of the present embodiment. Such an SEM image is an image obtained by binarizing an SEM image photograph obtained by photographing a predetermined visual field in a region closest to the inner side, in a total of four visual fields consisting of a visual field including the inner surface, a visual field including the outer surface of the membrane, and two fields of vision photographed at equal intervals between the these visual fields, in the SEM images of a membrane cross section in a membrane thickness direction orthogonal to the inner surface of the porous membrane.

In addition, in the aforementioned each region, the difference in distribution of the resin portion, i.e., anisotropy of percolativity, between the membrane cross section in the membrane thickness direction orthogonal to the inner surface of the hollow fiber porous membrane and the cross section parallel to the inner surface, is virtually negligible.

In the present description, the term “resin portion” is a dendritic skeleton portion of a three-dimensional network structure consisted of a resin that forms a large number of pores in a porous membrane. A black portion in FIG. 1 is a resin portion, and a white portion is a pore.

Inside the porous membrane, a percolated pore that is bent, twisted and percolated from an inside to an outside of the membrane is formed, and if a total area of a resin portion having an area of 1 μm² or less is 70% or more relative to a total area of the resin portion in each region of a total of four visual fields consisting of a visual field including the inner surface, a visual field including the outer surface of the membrane, and two fields of vision photographed at equal intervals between the these visual fields, in SEM images of a membrane cross section in a membrane thickness direction orthogonal to the inner surface of the porous membrane, the flux (water permeability, water permeation property) of a liquid to be treated is high, and the effect of backwash is enhanced. Moreover, a porous membrane having high percolativity of fine pores forms a seamless network structure of the backbone polymer. Such a membrane has a high toughness, and is also robust against damage to the membrane by stress concentration generated due to physical oscillation of the membrane such as air bubbling, etc. Furthermore, the membrane having such high percolativity has a tensile modulus of elasticity of 30 to 120 MPa and oscillation of the membrane having such optimum modulus of elasticity enables to eliminate a suspended substance attaching on the membrane surface. However, if a proportion of a total area of a resin portion having an area of 1 μm² or less with respect to a total area of the resin portion, is too high, a dendritic skeleton portion of a three-dimensional network structure consisted of a resin that forms a large number of pores in a porous membrane becomes too thin, and therefore, a total area of a resin portion having an area of greater than 1 μm² is preferably 2% or more and 15% or less relative to the total area of the resin portion while maintaining a total area of a resin portion having an area of 1 μm² or less of 70% or more relative to the total area of the resin portion, more preferably a total area of a resin portion having an area of 10 μm² or more is 15% or less relative to the total area of the resin portion, and still more preferably a total area of a resin portion having an area of greater than 1 μm² and less than 10 μm² is 15% or less relative to the total area of the resin portion as well as a total area of a resin portion having an area of 10 μm² or more is 2% or more and 15% or less relative to the total area of the resin portion. If a total area of the resin portion having an area of greater than 1 μm² is 2% or more and 30% or less with respect to the total area of the resin portion, the dendritic skeleton portion of the three-dimensional network structure consisted of the resin does not become too thin, therefore being capable of appropriately maintaining the strength of the porous membrane and the tensile elongation at break.

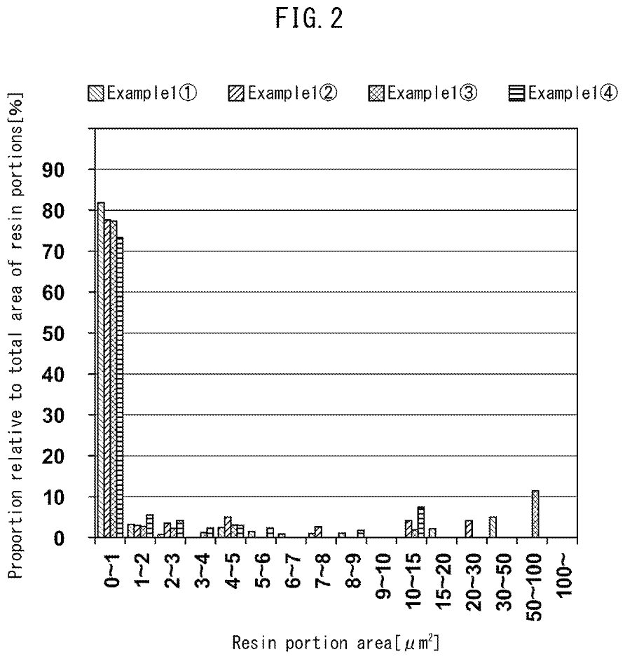

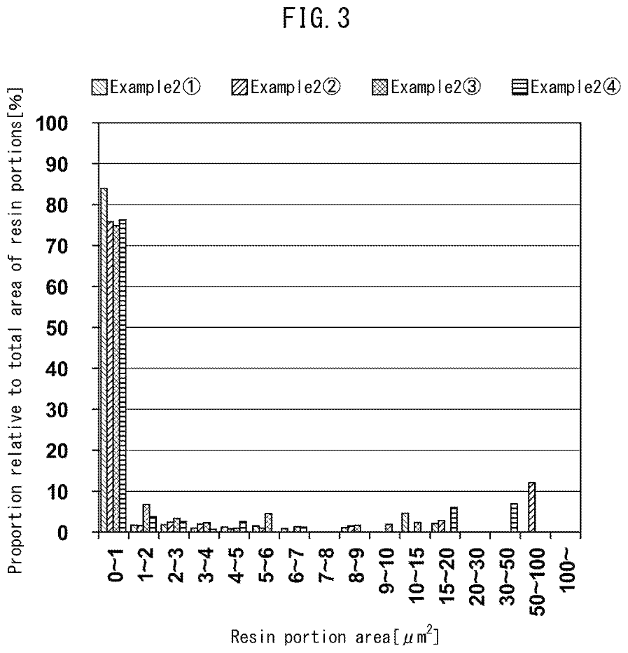

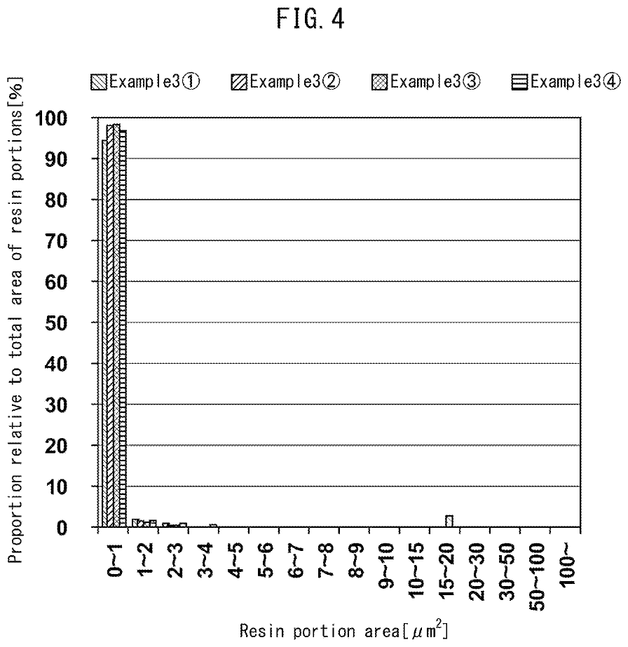

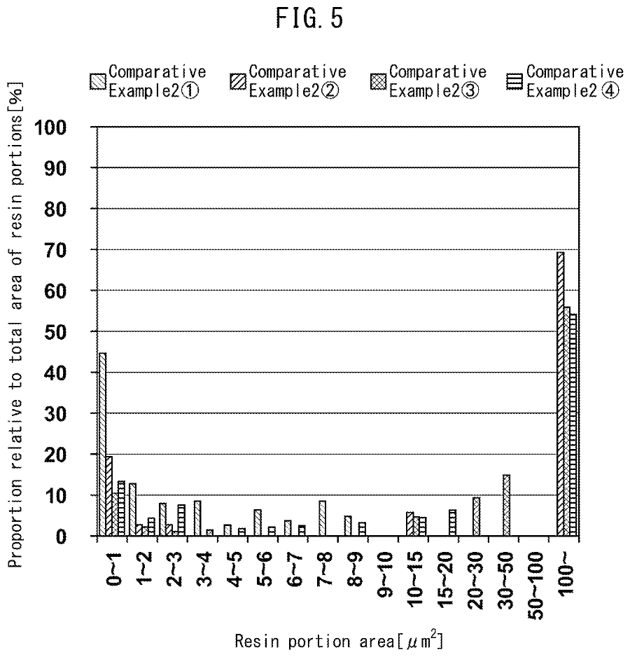

FIGS. 2 to 5 are each a histogram illustrating a proportion (%) of a total area of the resin portion having the prescribed area with respect to the total area of the resin portion in each region (1 in circle to 4 in circle) of a total of 4 visual fields consisting of a visual field including the inner surface, a visual field including the outer surface of the membrane, and two fields of vision photographed at equal intervals between the these visual fields, in SEM images of a membrane cross section in a membrane thickness direction orthogonal to the inner surface of the porous membrane used in Example 1, Example 2, Example 3, and Comparative Example 2, respectively. In FIG. 1, the resin portion appears in a granular form. In FIGS. 2 to 5, the areas of the granular resin portions are each measured, and for each area of the granular resin portions, the proportion of the area with respect to the total area of the entire resin portion in the visual field with the predetermined size of each region is illustrated as a histogram. The each 1 in circle in FIGS. 2 to 5 is the number of a region of the innermost side and the each 4 in circle is the number of a region of the outermost side, among a total of 4 visual fields consisting of a visual field including the inner surface, a visual field including the outer surface of the membrane, and two fields of vision photographed at equal intervals between these visual fields, in SEM images of a membrane cross section in a membrane thickness direction orthogonal to the inner surface of the porous membrane. For example, the 1 in circle of Example 1 is a histogram when the visual field with the prescribed size in the innermost region of the porous hollow fiber membrane of Example 1 is photographed. The measurement method of area distribution of a resin portion in each region of the porous hollow fiber membrane will be described below.

The surface opening ratio of the porous membrane is preferably 25 to 60%, more preferably 25 to 50%, and further preferably 25 to 45%. If the surface opening ratio on the side in contact with a liquid for treatment is 25% or more, clogging of pores and deterioration of the water permeability due to membrane surface abrasion are reduced, so that the filtration stability can be improved. On the other hand, if the surface opening ratio is high and the pore diameter is too large, the required separation performance may not be exhibited. Therefore, the average pore diameter of the porous membrane is preferably 10 to 700 nm and more preferably 20 to 600 nm. When the average fine pore diameter is 30 to 600 nm, the separation performance is sufficient, and the pore percolativity can be secured. The measurement methods of the surface opening ratio and the average pore diameter will be described later.

The membrane thickness of the porous membrane is preferably 80 to 1,000 μm and more preferably 100 to 300 μm. If the membrane thickness is 80 μm or more, the membrane strength can be ensured. On the other hand, if it is 1000 μm or less, the pressure loss due to the membrane resistance is small.

In Examples, a hollow fiber type porous hollow fiber membrane is used as the porous membrane, but the present invention is not limited thereto, and a flat membrane or a tubular membrane may be used. Moreover, it is more preferable to use a porous hollow fiber membrane, and by using the porous hollow fiber membrane, the membrane area per module unit volume can be increased. An example of a shape of the porous hollow fiber membrane includes an annular single-layer membrane, but it may be a multilayer membrane having different pore sizes in the separation layer and the support layer supporting the separation layer. Further, the cross-sectional structure may be irregular, such as having protrusions, etc., on the inner surface and the outer surface of the membrane.

The porosity of the porous hollow fiber membrane 10 is preferably 50 to 80% and more preferably 55 to 65%. When the porosity is 50% or more, the water permeability is high, on the other hand, when it is 80% or less, the mechanical strength can be increased.

Further, the porous hollow fiber membrane used in the method of filtration of the present embodiment preferably has a three-dimensional network structure instead of a spherulite structure. By rendering the three-dimensional network structure of the membrane, the percolativity of pores formed from the inner surface to the outer surface of the porous hollow fiber membrane can be improved.

Moreover, in the cleaning step in the method of filtration of the present embodiment, back pressure water washing (also referred to as backwash) for removing deposits on the filtration surface (outer surface) of the porous hollow fiber membrane by passing and ejecting a cleaning solution (may be a filtrate or include a chemical solution) into the direction opposite to the filtration direction, i.e., from the filtrate side to the side of the filtrate to be filtered, air bubbling (AB) for removing deposits (suspended substances) adhering to the hollow fiber membrane by oscillating the porous hollow fiber membrane with an aid of air bubbles, and simultaneous air bubbling plus backwash of carrying out backwash (BW) and air bubbling simultaneously, can be carried out in any combination. Accordingly, “backwash of passing a cleaning solution through the porous membrane from the inner surface of the porous membrane and air bubbling” in the cleaning step of the present embodiment includes simultaneous air bubbling plus backwash—flushing, backwash—simultaneous air bubbling plus backwash—flushing, and further, backwash alone, air bubbling alone and simultaneous air bubbling plus backwash, can be arbitrarily combined. The air amount (AB flow rate) of the air bubbling is preferably 170 to 400 Nm³/h, more preferably 200 to 350 Nm³/h, and still more preferably 200 to 300 Nm³/h, per 1 m² of the cross-sectional area of the membrane module. The flow rate of the backwash water is preferably 0.5 to 3 times the filtration flux and more preferably 1 to 3 times.

In the subsequent discharging step, the cleaned liquid (drainage) containing a lot of suspended substances remaining inside the module is discharged outside the module. In this case, when the liquid is pressurized with pressurized air from the side nozzle of the module and discharged from the lower part of the module, it can be completely and quickly discharged, and consequently, a high cleaning effect is obtainable.

### <Material (Material Quality) of Porous Membrane (Porous Hollow Fiber Membrane)>

The resin constituting the porous membrane is preferably a thermoplastic resin and more preferably a fluororesin. The fluororesin includes one selected from the group consisting of a vinylidene fluoride resin (PVDF), chlorotrifluoroethylene resin, tetrafluoroethylene resin, ethylene-tetrafluoroethylene copolymer (ETFE), ethylene-monochlorotrifluoroethylene copolymer (ECTFE), hexafluoropropylene resin and mixtures of these resins.

Examples of the thermoplastic resin include polyolefin, copolymer of olefin and halogenated olefin, halogenated polyolefin, and mixtures thereof. Examples of the thermoplastic resin include polyethylene, polypropylene, polyvinyl alcohol, ethylene-vinyl alcohol copolymer, ethylene-tetrafluoroethylene copolymer, polyvinylidene difluoride (may include a hexafluoropropylene domain), and mixtures thereof. Since these resins are thermoplastic and excellent in handleability and toughness, these are excellent as membrane materials. Among these, the vinylidene fluoride resin, tetrafluoroethylene resin, hexafluoropropylene resin or a mixture thereof, homopolymers or copolymers of ethylene, tetrafluoroethylene, and chlorotrifluoroethylene, or a mixture of the homopolymer and the copolymer, are preferable because these are excellent in mechanical strength, chemical strength (chemical resistance) and also favorable in moldability. More specifically, fluororesins such as polyvinylidene difluoride, vinylidene fluoride-hexafluoropropylene copolymer, ethylene-tetrafluoroethylene copolymer, ethylene-chlorotrifluoroethylene copolymer, etc., are included.

The porous membrane can contain up to about 5% by weight of components (impurities, etc.) other than the thermoplastic resin. For example, the solvent used upon the manufacture of the porous membrane can be contained. As will be described later, a first solvent (hereinafter also referred to as a non-solvent), a second solvent (hereinafter also referred to as a good solvent or a poor solvent) used as a solvent upon the manufacture of the porous membrane, or both thereof are included. These solvents can be detected by pyrolysis GC-MS (gas chromatography mass spectrometry).

The first solvent can be at least one type selected from the group consisting of sebacic acid ester, citric acid ester, acetyl citrate ester, adipic acid ester, trimellitic acid ester, oleic acid ester, palmitic acid ester, stearic acid ester, phosphoric acid ester, fatty acid having 6 or more and 30 or less carbon atoms, and epoxidized vegetable oil.

Also, other than the first solvent, the second solvent can be at least one type selected from the group consisting of sebacic acid ester, citrate ester, acetyl citrate ester, adipic acid ester, trimellitic acid ester, oleic acid ester, palmitic acid ester, stearic acid ester, phosphorus acid ester, fatty acid having 6 or more and 30 or less carbon atoms, and epoxidized vegetable oil. Examples of the fatty acid having 6 or more and 30 or less carbon atoms include capric acid, lauric acid, oleic acid, etc. Moreover, as epoxidized vegetable oil, epoxidized soybean oil, epoxidized linseed oil, etc., are included.

The first solvent is preferably the non-solvent such that a thermoplastic resin does not uniformly dissolve in the first solvent even if, in the first mixed solution having a ratio of the thermoplastic resin to the first solvent of 20:80, a temperature of the first mixed solution is increased to the boiling point of the first solvent.

The second solvent is preferably a good-solvent such that the thermoplastic resin uniformly dissolves in the second solvent, in the second mixed solution having a ratio of the thermoplastic resin to the second solvent of 20:80, at any temperature of the second mixed solution that is higher than 25° C. and below the boiling point of the second solvent.

It is more preferred that in the second mixed solution having a ratio of the thermoplastic resin to the second solvent of 20:80, the second solvent is a poor solvent such that the thermoplastic resin does not uniformly dissolve in the second solvent at a second mixed solution temperature of 25° C., and uniformly dissolves in the second solvent at any temperature of the second mixed solution that is higher than 100° C. and below the boiling point of the second solvent.

Further, in the method of filtration of the present embodiment, a porous hollow fiber membrane using polyvinylidene difluoride (PVDF) as the thermoplastic resin and containing the first solvent (non-solvent) can be used.

In this case, the first solvent is at least one type selected from the group consisting of sebacic acid ester, citric acid ester, acetyl citrate ester, adipic acid ester, trimellitic acid ester, oleic acid ester, palmitic acid ester, stearic acid ester, phosphoric acid ester, fatty acid having 6 or more and 30 or less carbon atoms and epoxidized vegetable oil, and in the first mixed solution having a ratio of polyvinylidene difluoride to the first solvent of 20:80, it can be the non-solvent such that polyvinylidene difluoride does not uniformly dissolve in the first solvent even if a temperature of the first mixed solution is raised to the boiling point of the first solvent. As the non-solvent, bis-2-ethylhexyl adipate (DOA) is preferred.

Further, the aforementioned porous hollow fiber membrane may contain a second solvent other than the first solvent. In this case, the second solvent is at least one type selected from the group consisting of sebacic acid ester, citric acid ester, acetyl citrate ester, adipic acid ester, trimellitic acid ester, oleic acid ester, palmitic acid ester, stearic acid ester, phosphoric acid ester, fatty acid having 6 or more and 30 or less carbon atoms, and epoxidized vegetable oil, and in a second mixed solution having a ratio of the thermoplastic resin to the second solvent of 20:80, it is preferably a good-solvent such that polyvinylidene difluoride uniformly dissolves in the second solvent at any temperature of a second mixed solution that is higher than 25° C. and below the boiling point of the second solvent. Moreover, the second solvent is more preferably a poor solvent such that polyvinylidene difluoride does not uniformly dissolve in the second solvent at a second mixed solution temperature of 25° C., and uniformly dissolves in the second solvent at any temperature of the second mixed solution that is higher than 100° C. and below the boiling point of the second solvent. As the poor solvent, tributyl acetyl citrate (ATBC) is preferable.

### <Physical Properties of Porous Membrane>

An initial value of a tensile elongation at break of the porous membrane is preferably 60% or more, more preferably 80% or more, still more preferably 100% or more, and particularly preferably 120% or more. The tensile elongation at break can be measured by the measurement method in Examples to be described below.

Alkali resistance can be measured by a retention ratio (elongation retention ratio after NaOH immersion) of the tensile elongation at break before and after alkali immersion of the porous membrane, and the tensile elongation at break (corresponding to the tensile elongation at break E1 of the porous hollow fiber membrane after the cleaning step) after having been immersed in a 4% by weight NaOH aqueous solution for 10 days, is retained preferably 80% or more, more preferably 85% or more, and still more preferably 90% or more, relative to the initial value (corresponding to the tensile elongation at break E0 of the porous hollow fiber membrane before the cleaning step),

From a viewpoint of practical use, the compressive strength of the porous membrane is preferably 0.2 MPa or more, more preferably 0.3 to 1.0 MPa, and still more preferably 0.4 to 1.0 MPa.

### <Water Permeability of Porous Membrane>

The relationship between the water permeability Ln of the porous membrane after repeating the filtration step n times and the water permeability Ln+1 of the porous membrane immediately after the subsequent cleaning step is preferably 105%≥Ln+1/Ln×100≥80%. The water permeability is a value [LMH/kPa] obtained by dividing the filtration flux [LMH] by the pressure [kPa] of that time.

In the method of filtration of the embodiments, after the aforementioned cleaning step, a discharging step of discharging the cleaning solution remaining inside the porous membrane is carried out. According to the discharging step, for example, by introducing pressurized air from the side nozzle of the membrane module, the cleaning solution remaining inside the membrane module is forcibly discharged from the lower part of the membrane module. The weight of the module after the discharging step is preferably 1.7 times or less the initial dry weight of the membrane module, more preferably 1.6 times or less, and even more preferably 1.55 times or less.

The number of broken yarns in a hollow fiber membrane is 0.5% or less of the total number of yarns inside the module, preferably after repeating the aforementioned filtration step, the aforementioned cleaning step, and the aforementioned discharging step 20,000 times, more preferably after repeating the steps 100,000 times, and furthermore preferably after repeating the steps 200,000 times.

### <Porous Hollow Fiber Membrane Production Method>

Hereinafter, a method for producing a porous hollow fiber membrane will be described below provided that the method of manufacturing the porous hollow fiber membrane used for the method of filtration of the present embodiment is not limited to the following production methods.

The method for producing a porous hollow fiber membrane used in the method of filtration of the present embodiment enables to include (a) a step of preparing a melt-kneaded product containing a thermoplastic resin, solvent and additive, (b) a step of supplying the melt-kneaded product to a multi-structure spinning nozzle and extruding the melt-kneaded product from the spinning nozzle to obtain a hollow fiber membrane, and a step (c) of extracting the solvent from the hollow fiber membrane. When the melt-kneaded product contains an additive, a step of extracting the additive from the hollow fiber membrane after the step (c) may further be comprised.

The concentration of the thermoplastic resin of the melt-kneaded product is preferably 20 to 60% by weight, more preferably 25 to 45% by weight, and further preferably 30 to 45% by weight. If this value is 20% by weight or more, the mechanical strength can be increased, and if it is 60% by weight or less, the water permeability can be increased. The melt-kneaded product may contain an additive.

The melt-kneaded product may be consisted of two components of a thermoplastic resin and a solvent or may be consisted of three components of the thermoplastic resin, an additive, and the solvent. As will be described below, the solvent contains at least the non-solvent.

As the extractant used in step (c), it is preferable to use a liquid that does not dissolve the thermoplastic resin but has high affinity with solvents such as methylene chloride and various alcohols.

When using a melt-kneaded product containing no additive, a hollow fiber membrane obtained through step (c) may be used as the porous hollow fiber membrane. In the case of producing a porous hollow fiber membrane using a melt-kneaded product containing the additive, it is preferable to further employ step (d) of extracting the additive from a hollow fiber membrane to obtain a porous hollow fiber membrane after step (c). As the extractant in step (d), it is preferred to use a liquid using hot water, acid or alkali that can dissolve the additive but does not dissolve a thermoplastic resin.

An inorganic material may be used as an additive. The inorganic material is preferably inorganic fine powder. The primary particle diameter of the inorganic fine powder contained in the melt-kneaded product is preferably 50 nm or less, more preferably 5 nm or more and less than 30 nm. Specific examples of the inorganic fine powder include silica (including fine powder silica), titanium oxide, lithium chloride, calcium chloride, organic clay, etc. Among these, fine silica powder is preferable from the viewpoint of cost. The aforementioned “primary particle diameter of inorganic fine powder” means a value obtained from analysis of an electron micrograph. Accordingly, first, a group of inorganic fine powder is pretreated by the method of ASTM D3849. Thereafter, the particle diameters of 3000 to 5000 particles copied in the transmission electron micrograph are measured, and the primary particle diameter of the inorganic fine powder can be calculated by arithmetically averaging these obtained values.

About inorganic fine powder inside the porous hollow fiber membrane, the element (material) of the existing inorganic fine powder can be identified by identifying the element which exists by fluorescent X-rays measurement, etc.

When an organic substance is used as an additive, hydrophilicity can be imparted to the hollow fiber membrane by using hydrophilic polymers such as polyvinyl pyrrolidone, polyethylene glycol, etc. Moreover, the viscosity of the melt-kneaded product can be controlled by using additives having a high viscosity such as glycerin, ethylene glycol, etc.

A membrane is fabricated by mixing a thermoplastic resin, solvent, and inorganic fine powder, but the solvent is preferably the non-solvent for the thermoplastic resin, and the inorganic fine powder is hydrophobic, so that a three-dimensional network structure is easily formulate. Due to such a three dimensional network structure, the membrane having enhanced toughness and sufficient resistance to intense physical cleaning, is obtained.

Next, step (a) of preparing a melt-kneaded product in the method for producing the porous hollow fiber membrane of the present embodiment will be described in detail.

In the method for producing the porous hollow fiber membrane of the present embodiment, the non-solvent for a thermoplastic resin is mixed with a good solvent or a poor solvent. The mixed solvents after mixing become the non-solvent for the thermoplastic resin used. Thus, when such a non-solvent is used as a raw material for the membrane, a porous hollow fiber membrane having a three-dimensional network structure is obtained. The mechanism of action thereof is not necessarily clear, but it is conjectured that the use of a solvent with a lower solubility by mixing the non-solvent moderately inhibits the crystallization of the polymer and is likely to induce formation of the three-dimensional network structure. The membrane having the three-dimensional network structure has high percolativity and a moderately high degree of crystallinity, so that the tensile modulus of elasticity falls within the range of 30 to 120 MPa. For example, the non-solvent and poor solvent or good solvent are selected from the group consisting of phthalic acid ester, sebacic acid ester, citric acid ester, acetyl citratic acid ester, adipic acid ester, trimellitic acid ester, oleic acid ester, palmitic acid ester, stearic acid ester, phosphate ester, fatty acid having 6 or more and 30 or less carbon atoms, various esters such as an epoxidized vegetable oil, etc.

A solvent that can dissolve the thermoplastic resin at room temperature is a good solvent, a solvent that cannot dissolve it at room temperature but can dissolve it at an elevated temperature is a poor solvent for the thermoplastic resin, and a solvent that cannot dissolve it even at an elevated temperature is referred to as the non-solvent, and the good solvent, poor solvent, and non-solvent can be judged as follows.

About 2 g of a thermoplastic resin and about 8 g of a solvent are put into a test tube, heated to the boiling point of the solvent in about steps of 10° C. with a block heater for the test tube, stirred inside of the test tube with a spatula, etc., and a solvent that dissolves the thermoplastic resin can be judged as a good or poor solvent, and a solvent that does not dissolve it is the non-solvent. A solvent that dissolves at a relatively low temperature of 100° C. or lower is judged as a good solvent, and a solvent that does not dissolve unless heated to 100° C. or higher and an elevated temperature of the boiling point or lower is judged as a poor solvent.

For example, when polyvinylidene difluoride (PVDF) is used as the thermoplastic resin and acetyl tributyl citrate (ATBC), dibutyl sebacate or dibutyl adipate is used as the solvent, PVDF is uniformly mixed with these solvents and dissolved at about 200° C. On the other hand, when bis-2-ethylhexyl adipate (DOA), diisononyl adipate, or bis-2-ethylhexyl sebacate is used as the solvent, PVDF does not dissolve in these solvents even if the temperature is increased to 250° C.

Further, when ethylene-tetrafluoroethylene copolymer (ETFE) is used as the thermoplastic resin and diethyl adipate is used as the solvent, ETFE is uniformly mixed and dissolved at about 200° C. On the other hand, when bis-2-ethylhexyl adipate (DIBA) is used as the solvent, ETFE does not dissolve.

Moreover, when ethylene-monochlorotrifluoroethylene copolymer (ECTFE) is used as the thermoplastic resin and triethyl citrate is used as the solvent, ECTFE is uniformly dissolved at about 200° C., and when triphenyl phosphite (TPP) is used, ECTFE does not dissolve.

The porous membrane used in the method of filtration of the present embodiment can be used as a microfiltration (MF) membrane or an ultrafiltration (UF) membrane.

A publicly known RO membrane can be used as the RO means.

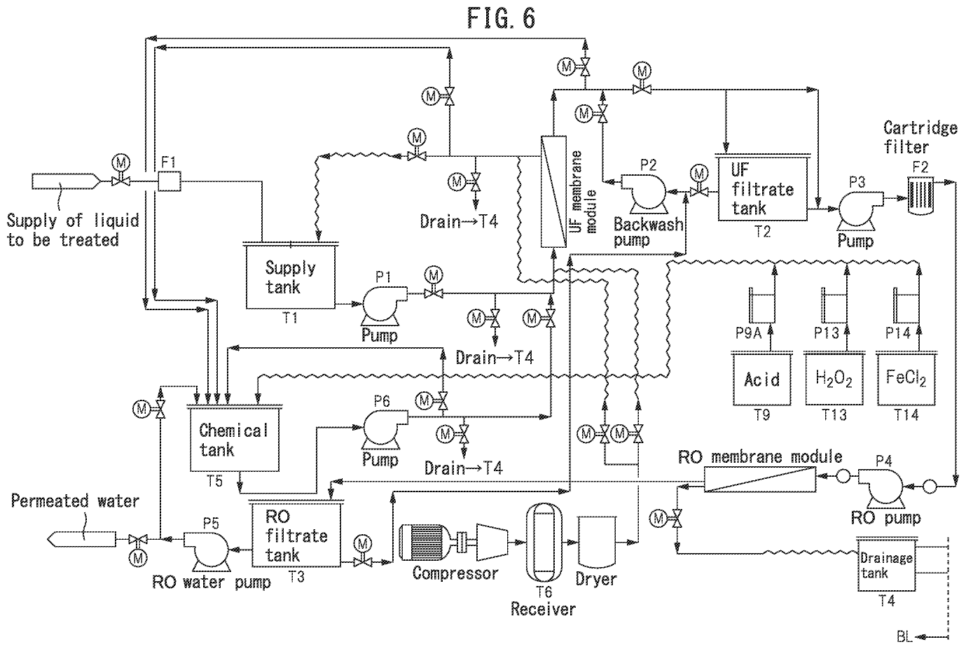

FIG. 6 is a flowchart illustrating an example of a filtration system including an ultrafiltration (UF) means, a reverse osmosis (RO) means, a backwash means, and an air bubbling means, using a porous membrane. First, the liquid to be treated is separated into treated water (filtrate) and drainage containing suspended matters, etc., by the UF membrane. The filtrate is stored in the UF filtrate tank (T2), and the liquid containing the suspended liquid, etc., is sent as a drain to the drainage tank (T4). The UF filtrate passes through the cartridge filter and is sent to the RO membrane module. A part of the UF filtrate is stored in the RO filtrate tank (T3) as permeated water, and the remaining portion is sent to the drainage tank (T4).

As shown in FIG. 6, the filtrate in the UF filtrate tank (T2) is sent as a rinse liquid by the backwash pump (P2), and the UF membrane is cleaned by the backwash and air bubbling using pressurized air. Thereafter, the residual solution of the cleaning solution is drained from the lower part of the membrane module by the pressurized air from the side nozzle.

### EXAMPLES

The present invention will be specifically described below by way of the examples. Naturally, the present invention is not limited to these. The method of producing porous hollow fiber membranes used in Examples and Comparative Examples, filtration test, breakage test and measurement methods of each physical property, etc., are as described below.

### (1) Outer Diameter and Inner Diameter of Porous Hollow Fiber Membrane

A porous hollow fiber membrane was sliced thinly with a razor blade in a cross section orthogonal to the length direction, and the outer diameter and inner diameter were measured with a 100 Times magnifier. For each sample, a total of 60 cut surfaces at intervals of 30 mm in the length direction were measured, and the average value of the outer diameters and that of the inner diameters of the hollow fiber membrane, were an outer diameter and inner diameter, respectively.

### (2) Electron Microscope Photography

A porous hollow fiber membrane was cut into an annular shape in a cross section thereof perpendicular to the length direction, stained with 10% phosphotungstic acid plus osmium tetroxide, and embedded in an epoxy resin. Next, after trimming, the cross section of the sample was subjected to BIB processing to prepare a smooth cross section, and a conductive treatment was carried out to prepare a microsection. Using the microsection and an electron microscope SU8000 series manufactured by Hitachi, Ltd., electron microscope (SEM) images of the cross section of the membrane were photographed with magnification of 5,000 to 30,000× at an accelerating voltage of 1 kV in each region (1 in circle to 4 in circle in FIGS. 2 to 5) of the predetermined visual fields such as the total of four visual fields consisting of the visual field including the inner surface of the cross section of membrane (thickness portion), the visual field including the outer surface of the membrane, and two fields of vision photographed at equal intervals between the these visual fields. These images can be measured by changing the magnification according to the average pore diameter. Specifically, when the average pore diameter is 0.1 μm or more, the magnification is 5000 times, and when the average pore diameter is 0.05 μm or more and less than 0.1 μm, it is 10,000 times. In the case of the average pore diameter of less than 0.05 μm, it was set to 30,000 times. It is noted that the field size was 2560×1920 pixels.

For image processing, an Image J was used and the photographed SEM image was binarized into a pore portion and a resin portion by applying a Threshold processing (Image-Adjust-Threshold: Otsu method (Otsu is selected)) to the SEM image.

Surface opening ratio: It was measured by calculating the ratio between the resin portion and the pore portion of the binarized image.

Area distribution of resin portion: Using Image J's “Analyze Particle” command (Analyze Particle: Size 0.10-Infinity), the size of each binarized granular resin portion included in the photographed SEM image was measured. When the total area of the entire resin portion included in the SEM images is ΣS and the area of the resin portion of 1 μm² or less is ΣS (<1 μm²), an area ratio of the area of the resin portion of 1 μm² or less was calculated by calculating ΣS (<1 μm²)/ΣS. Similarly, the area ratio of the resin portion having an area in the predetermined range was calculated.

It is noted that, regarding noise removal upon carrying out the binarization process, the resin portion having the area less than 1 μm² was removed as noise, and the resin portion with the area of 1 μm² or more was applied for the analysis. The noise removal was carried out using a median filter processing (Process-Filters-Median: Radius: 3.0 pixels).

Moreover, the granular resin portion cut at the edge of the SEM image was also applied for measurement. In addition, the process of “Include Holes” (fill in hole) was not carried out. The process of correcting the shape from a “snowman” type to a “flat” type, etc., was also not carried out.

Average fine pore diameter: It was measured using Image J's “Plugins-Bone J-Thickness” command. The space size was defined as the maximum circle size that can enter the pore.

### (3) Flux (Flux, Water Permeability, Initial Pure Water Flux)

After immersing the porous hollow fiber membrane in ethanol and then immersing it in pure water several times, one end of the wet hollow fiber membrane having a length of about 10 cm was sealed, and an injection needle was inserted into the hollow portion at the other end. Pure water at 25° C. was injected from the injection needle at a pressure of 0.1 MPa under an environment of 25° C., and the amount of pure water permeating from the outer surface of the membrane was measured. The pure water flux was determined using the equation below:

Initial pure water flux[L/m²/h=LMH]=60×(Permeated water amount[L])/{π×(Membrane outer diameter[m])×(Membrane effective length[m])×(Measurement time[min])}

and the water permeability was evaluated.

In is noted that the “membrane effective length” refers to the net membrane length excluding the portion where the injection needle is inserted.

### (4) Module Water Permeability Retention Ratio

When the river surface water (Fuji River surface water) was filtered using the fabricated membrane module, a series of the filtration process, cleaning process, and discharging process was regarded as one cycle, and the module water permeability ratio was determined by the equation below:

Water permeability retention ratio[%]=100×(water permeability of nth cycle[LMH/kPa])/(water permeability of 1st cycle[LMH/kPa])

In addition, each parameter was calculated by the following equations:

Filtration pressure={(input pressure)+(output pressure)}/2

Here, the filtration pressure indicates an average value over the entire time of the filtration process.

Outer membrane surface area[m²]=Number of hollow fiber membranes×TC×(Hollow fiber membrane outer diameter[m])×(Hollow fiber membrane effective length[m])

Also, all filtration pressures are calculated in terms of water viscosity at 25° C.

### (5) Tensile Elongation at Break (%), Tensile Modulus of Elasticity (MPa)

The porous hollow fiber membrane was used as it was as a sample, and the tensile elongation at break and tensile modulus of elasticity were calculated according to JIS K7161. The load and displacement upon tensile breakage were measured under the following conditions.

Measurement instrument: An Instron type tensile tester (AGS-5D manufactured by Shimadzu Corporation)

Chuck distance: 5 cm

Tension speed: 20 cm/minute

### (6) Fabrication of Hollow Fiber Membrane Module

A bundle of 6600 porous hollow fiber membranes at one end on the side where a hollow portion had been clogged with a hot melt adhesive, was cut into a length of 2.2 m and inserted into a housing in which two heads each having a side nozzle were welded to an upper and bottom of a pipe having an inner diameter of 154 mm, respectively.

Next, eight cylindrical restricting members each (in which an adhesive similar to the potting material described below was cast into a mold and cured in advance) having an outer diameter of 11 mm were inserted and arranged so as to be evenly distributed at one end of the hollow fiber membrane bundle on the side where the hollow portion had been clogged. In order to form a through hole at the other end of the hollow fiber membrane bundle, a polypropylene columnar member having favorable stripping property was inserted.

Next, a capping container for forming an adhesive fixing portion, to which a potting material introduction tube was attached was fixed to both ends of the housing, and the potting material was injected into both end portions of the housing while rotating the housing in the horizontal direction. As the potting material, a two-component thermosetting urethane resin (SA-6330A2/SA-6330B5 (trade name) manufactured by Sanyu Rec Co., Ltd.) was used. When the curing reaction of the potting material progressed and fluidization thereof stopped, the rotation of the centrifuge was stopped followed by removal of the centrifuge, and the potting material was cured by heating to 50° C. in an oven.

Thereafter, the end portion of the housing on the side where the hollow portion of the membrane was clogged was cut, and the hollow portion on the side where the hollow portion was clogged in the stage before the adhesion was opened. The polypropylene columnar member was removed from the other adhesive fixing portion to form a plurality of through holes. In such a manner, a one-end-opening external pressure type hollow fiber membrane module having an effective membrane length of 2 m and an effective membrane area of 50 m² was manufactured.

### (7) Hollow Fiber Membrane Module Filtration Test

Using the obtained hollow fiber membrane module, an experiment was carried out to filter actual seawater using the filtration system shown in FIG. 6. The filtration step in one cycle includes a filtration step of carrying out a filtration operation using the filtration pump P1, subsequently a cleaning step of carrying out separately or simultaneously an air bubbling cleaning (AB) using pressurized air produced by a compressor and backwash (BW) using filtered water by the backwash pump P2, and a discharging step of discharging a cleaning solution from the lower part of the module by gravity drop from the side nozzle of the hollow fiber membrane module or by introducing pressurized air of 0.1 MPa, or discharging a cleaning solution from the side nozzle by introducing raw water from the lower part of the module.

### (8) Hollow Fiber Membrane Module Integrity (Breakage) Test

After discharging the liquid inside the hollow fiber membrane module, pressurized air was introduced from the lower part of the membrane module and the filtration side was filled with water while maintaining the inside of the membrane module in a pressurized state of 0.1 MPa, and then an air leak from the broken membrane was detected in a transparent pipe that was partially provided to the main filtration pipe. If air bubbles were confirmed in the transparent pipe, indicating that the hollow fiber membrane was broken, and after finding the broken part at a cut end face of the module, the broken part (broken yarn) was closed at the cut end face by driving a nail. The membrane module integrity test was carried out once a day and the number of broken membranes was recorded.

### (9) Raw Water Average Turbidity (NTU)

Turbidity of raw water was measured constantly by using a TU5300 sc Online Laser Turbidimeters manufactured by HACH Company, and the average value was defined as the average turbidity during the experimental period.

### Example 1

A melt-knead product was prepared using 40% by weight of a PVDF resin (KF-W #1000 manufactured by Kureha Corporation) as a thermoplastic resin, 23% by weight of fine silica powder (primary particle size: 16 nm), 32.9% by weight of bis-2-ethylhexyl adipate (DOA) as the non-solvent, and 4.1% by weight of acetyl tributyl citrate (ATBC, boiling point of 343° C.) as a poor solvent. The temperature of the obtained melt-kneaded product was 240° C. The obtained melt-kneaded product was extruded in a form of hollow fiber from a double-pipe spinneret through a space having a free running distance of 120 mm and then solidified in water at 30° C., which developed the porous structure by thermally induced phase separation. The obtained hollow fiber extrudate was taken up at a speed of 5 m/minute and wound up in a skein. The taken-up hollow fiber extrudate was immersed in isopropyl alcohol to extract and remove DOA and ATBC, then immersed in water for 30 minutes to substitute the hollow fiber membrane with water, subsequently immersed in a 20% by weight NaOH aqueous solution at 70° C. for 1 hour, further washed with water for extraction and removal of the fine powder silica, and then to form a porous hollow fiber membrane. The obtained hollow fiber membrane had an inner diameter of 0.7 mm and an outer diameter of 1.2 mm.

Table 1 below shows the blending composition, production conditions, and various performances of the obtained porous membrane. The membrane had a three-dimensional network structure. Further the membrane was found to have high water permeability and high percolativity.

When a seawater filtration test was carried out using the obtained porous membrane module, no membrane was broken even when the cycle including the filtration step, the cleaning step, and the discharging step, was repeated 20,000 cycles. Moreover, it was able to operate smoothly and the water permeability retention ratio after an elapse of 20,000 cycles was 51%, and the water permeability retention ratio of the 19,999th cycle was 52%. Thereafter, when chemical cleaning was carried out by immersing in a 0.5% NaClO aqueous solution for 24 hours, the water permeability retention ratio was recovered to 85%.

The conditions of the cleaning step were as follows: backwash: 30 seconds, simultaneous air bubbling plus backwash: 1 minute, discharging step: 30 seconds, and filtration step: 28 minutes. Moreover, the filtration flux and the backwash flux were set to the same 80 LMH. Filtered water was used for the backwash solution. In the discharging step, the cleaning solution was discharged by introducing 0.2 MPa of pressurized air from the side nozzle. The module weight after discharging was 2.5 times the dry weight. In addition to the cleaning step, chemical cleaning is carried out once a month with a 0.5% NaClO aqueous solution.

### Example 2

A melt-kneaded product was prepared using 40% by weight of a ETFE resin (TL-081 manufactured by Asahi Glass Co., Ltd.,) as a thermoplastic resin, 23% by weight of fine silica powder (primary particle size: 16 nm), 32.9% by weight of bis(2-ethylhexyl) adipate (DOA) as the non-solvent, and 4.1% by weight of diisobutyl adipate (DIBA) as a poor solvent. The temperature of the obtained melt-kneaded product was 240° C. The resulting melt-kneaded product was extruded in a form of hollow fiber from a double-pipe spinneret through a space having a free running distance of 120 mm and then solidified in water at 30° C., and the porous structure was developed by thermally induced phase separation. The obtained hollow fiber extrudate was taken up at a speed of 5 m/minute and wound up in a skein. The taken-up hollow fiber extrudate was immersed in isopropyl alcohol to extract and remove DOA and DIBA, then immersed in water for 30 minutes to substitute the hollow fiber membrane with water, subsequently immersed in a 20% by weight NaOH aqueous solution at 70° C. for 1 hour, further washed with water for extraction and removal of fine powder silica, and then to fabricate the porous hollow fiber membrane. The obtained hollow fiber membrane had an inner diameter of 0.7 mm and an outer diameter of 1.2 mm. Moreover, the hollow fiber membrane module was fabricated in a similar manner as in Example 1.

Table 1 below shows the blending composition, production conditions, and various performances of the obtained porous membrane. The membrane had a three-dimensional network structure. Further the membrane was found to have high water permeability and high percolativity.

When a seawater filtration test was carried out using the obtained porous membrane module, the membrane was not broken even when the cycle from the filtration step, the cleaning step, and the discharging step was repeated 20,000 cycles. Moreover, it was able to operate smoothly and the water permeability retention ratio after an elapse of 20,000 cycles was 72%, and the water permeability retention ratio of the 19,999th cycle was 72.5%. Thereafter, when chemical cleaning was carried out by immersing in a 0.5% NaClO aqueous solution for 24 hours, the water permeability retention ratio was recovered to 87%.

The filtration step, the cleaning step, and the discharging step were carried out under the same conditions as in Example 1 with the exception of use of 50 mg/L hypochlorous acid aqueous solution as a backwash solution. The standard electrode potential of this backwash solution was about 1.7V. The module weight after the discharging step was measured and found to be 2.5 times the dry weight.

### Example 3

A melt-kneaded product was prepared using 40% by weight of a ECTFE resin (Halar 901 manufactured by Solvay Specialty Polymers, Inc.) as a thermoplastic resin, 23% by weight of fine silica powder (primary particle size: 16 nm), 32.9% by weight of triphenylphosphorous acid (TPP) as the non-solvent %, and 4.1% by weight of bis(2-ethylhexyl) adipate (DOA) as a poor solvent. The temperature of the obtained melt-kneaded product was 240° C. The resulting melt-kneaded product was extruded in a form of hollow fiber from a double-pipe spinneret through a space having a free running distance of 120 mm and then solidified in water at 30° C., and the porous structure was developed by thermally induced phase separation. The obtained hollow fiber extrudate was taken up at a speed of 5 m/minute and wound up in a skein. The taken-up hollow fiber extrudate was immersed in isopropyl alcohol to extract and remove TPP and DOA, then immersed in water for 30 minutes to substitute the hollow fiber membrane with water, subsequently immersed in a 20% by weight NaOH aqueous solution at 70° C. for 1 hour, further washed with water for extraction and removal of the fine powder silica, and then to fabricate the porous hollow fiber membrane. The obtained hollow fiber membrane had an inner diameter of 0.7 mm and an outer diameter of 1.2 mm.

Table 1 below shows the blending composition, production conditions, and various performances of the obtained porous membrane of Example 3. The membrane had a three-dimensional network structure. Further the membrane was found to have high water permeability and high percolativity.

When a seawater filtration test was carried out using the obtained porous membrane module, the membrane was not broken even when the cycle from the filtration step, the cleaning step, and the discharging step was repeated 20,000 cycles. Moreover, it was able to operate smoothly and the water permeability retention ratio after an elapse of 20,000 cycles was 71%, and the water permeability retention ratio of the 19,999th cycle was 71.5%. Thereafter, when chemical cleaning was carried out by immersing in a 0.5% NaClO aqueous solution for 24 hours, the water permeability retention ratio was recovered to 84%.

The filtration step, the cleaning step, and the discharging step were carried out under the same conditions as in Example 1 with the exception of using a backwash solution containing 0.01% iron (II) ions and 1% hydrogen peroxide, which was obtained by diluting a chemical solution with iron (II) and hydrogen peroxide adjusted to pH 2.8 with malic acid to a 1/200 concentration with water. The standard electrode potential of this backwash solution was about 2V. The module weight after the discharging step was measured and found to be 2.5 times the dry weight.

### Example 4

Two membrane modules prepared in Example 1 were used, and the membrane module filtration test was carried out under the conditions described in Table 1 below for the filtration step, the cleaning step, and the discharging step. The fluxes upon filtration and backwash were set to 80 LMH, and filtered water was used as the backwash solution. In this case, the filtrate turbidity (raw water average turbidity) was 10 on average. The water permeability retention ratio (%) after an elapse of 20,000 cycles was 70% under the above cleaning conditions.

### Comparative Example 1

A hollow fiber membrane of Comparative Example 1 was obtained in the same manner as in Example 1 with the exception of using only ATBC as the solvent. Table 2 below shows the blending composition, production conditions, and various performances of the obtained porous membrane. The membrane had a spherulite structure. Moreover, the membrane had low water permeability and was found to have low percolativity.

When a seawater filtration test was carried out using the obtained porous membrane modules, 70 modules were broken and the membrane breakage ratio was 1% when the cycle from the filtration step, the cleaning step, and the discharging step was repeated 20,000 cycles. Moreover, the water permeability retention ratio after an elapse of 20,000 cycles was 49%, and the water permeability retention ratio of the 19,999th cycle was 50%. Thereafter, when chemical cleaning was carried out by immersing in a 0.5% NaClO aqueous solution for 24 hours, the water permeability retention ratio was recovered to 76%.

The filtration step, the cleaning step, and the discharging step were carried out under the same conditions as in Example 1 and filtered water was used as a backwash solution. The module weight after the discharging step was measured and found to be 2.5 times the dry weight.

### Comparative Example 2

A hollow fiber membrane of Comparative Example 2 was obtained in the same manner as in Example 1 with the exception of the amount of silica being 0% and using γ-butyrolactone alone as the solvent. Table 2 below shows the blending composition, production conditions, and various performances of the obtained porous membrane of Comparative Example 2. The membrane had a spherulite structure. Moreover, the membrane had low water permeability and was found to have low percolativity.

When a seawater filtration test was carried out using the obtained porous membrane modules, 70 modules were broken and the membrane breakage ratio was 1% when the cycle from the filtration step, the cleaning step, and the discharging step was repeated 20,000 cycles. Moreover, the water permeability retention ratio after an elapse of 20,000 cycles was 40%, and the water permeability retention ratio of the 19,999th cycle was 41%. Thereafter, when chemical cleaning was carried out by immersing in a 0.5% NaClO aqueous solution for 24 hours, the water permeability retention ratio was recovered to 77%.

The filtration step, the cleaning step, and the discharging step were carried out under the same conditions as in Example 1 and filtered water was used as a backwash solution. The module weight after the discharging step was measured and found to be 2.5 times the dry weight.

### Comparative Example 3

Two membrane modules prepared in Example 1 were used, and the membrane module filtration test was carried out under the conditions described in Table 2 below for the filtration step, the cleaning step, and the discharging step. The fluxes upon filtration and backwash were set to 80 LMH, and filtered water was used as the backwash solution. In this case, the filtrate turbidity (raw water average turbidity) was 10 on average. The water permeability retention ratio (%) after an elapse of 20,000 cycles was 45% under the above cleaning conditions.

As described above, it has been found that differences in filtration performance, cleaning efficiency, and lifetime (durability) are arisen due to the difference in the membrane structure. The membrane having better percolativity was found to be superior in filtration performance, cleaning efficiency, and durability. Moreover, it has turned out that the filtration operation can be achieved more stably for highly turbid water to be filtered than when simultaneous air bubbling plus backwash are carried out individually.

TABLE 1

| | Example 1 | Example 2 | Example 3 | Example 4 |
|---|---|---|---|---|
| Resin | PVDF KF | ETFE | ECTFE | PVDF KF |
| | W#1000 40% | TL-081 40% | Halar901 40% | W#1000 40% |
| Additive | Fine silica | Fine silica | Fine silica | Fine silica |
| | powder 23% | powder 23% | powder 23% | powder 23% |
| Non-solvent | DOA: 32.9% | DOA: 32.9% | TPP: 32.9% | DOA: 32.9% |
| Poor solvent | ATBC: 4.1% | DMA: 4.1% | DOA: 4.1% | ATBC: 4.1% |
| Extrusion temperature of stock solution for membrane | 240 | 240 | 240 | 240 |
| fabrication [° C.] | | | | |
| Coagulation liquid | Water | Water | Water | Water |
| Coagulation liquid temperature [° C.] | 30 | 30 | 30 | 30 |
| Free running distance [mm] | 120 | 120 | 120 | 120 |
| Fine pore diameter [nm] | 500 | 600 | 400 | 150 |
| Fine pore structure | 3 dimensional | 3 dimensional | 3 dimensional | 3 dimensional |
| | networks | networks | networks | networks |
| Surface opening ratio [%] | 30 | 30 | 30 | 30 |
| Water permeability [L/(m² · h)] | 4,000 | 5,000 | 3,500 | 4,000 |
| Outer diameter/inner diameter [mm] | 1.2/0.7 | 1.2/0.7 | 1.2/0.7 | 1.2/0.7 |
| Tensile elongation at break [%] | 170 | 160 | 180 | 170 |
| Tensile modulus of elasticity [MPa] | 90 | 100 | 90 | 90 |
| Proportion of resin portion with 1 um² or less by image analysis 1 | 82 | 84 | 94 | 82 |
| Proportion of resin portion with 1 um² or less by image analysis 2 | 78 | 76 | 98 | 78 |
| Proportion of resin portion with 1 um² or less by image analysis 3 | 77 | 75 | 98 | 77 |
| Proportion of resin portion with 1 um² or less by image analysis 4 | 73 | 76 | 97 | 73 |
| Proportion of resin portion with 10 um² or more by image analysis 1 | 7 | 7 | 3 | 7 |
| Proportion of resin portion with 10 um² or more by image analysis 2 | 8 | 15 | 0 | 8 |
| Proportion of resin portion with 10 um² or more by image analysis 3 | 13 | 2 | 0 | 13 |
| Proportion of resin portion with 10 um² or more by image analysis 4 | 7 | 13 | 0 | 7 |
| Raw water average turbidity | 3 | 3 | 3 | 10 |
| Time conditions for each step | Filtration: 28.5 | Filtration: 28.5 | Filtration: 28.5 | Filtration: 28.5 |
| | minutes [symbol] | minutes [symbol] | minutes [symbol] | minutes [symbol] |
| | AB/BW: 1 | AB/BW: 1 | AB/BW: 1 | AB/BW: 1 |
| | minutes [symbol] | minutes [symbol] | minutes [symbol] | minutes [symbol] |
| | Drain: 0.5 minutes | Drain: 0.5 minutes | Drain: 0.5 minutes | Drain: 0.5 minutes |
| AB flow rate/backwash (BW) flow rate | 5 Nm³/h/4m³/h | 5 Nm³/h/4m³/h | 5 Nm³/h/4m³/h | 7 Nm³/h/4m³/h |

TABLE 2

| | Comparative Example 1 | Comparative Example 2 | Comparative Example 3 |
|---|---|---|---|
| Resin | PVDF KF W#1000 40% | PVDF KF W#1000 40% | PVDF KF W#1000 40% |
| Additive | Fine silica powder 23% | — | Fine silica powder 23% |
| Non-solvent | — | — | DOA: 32.9% |
| Poor solvent | ATBC: 37% | γ-butyrolactone 60% | ATBC: 4.1% |
| Extrusion temperature of stock solution for membrane fabrication | 240 | 200 | 240 |
| [° C.] | | | |
| Coagulation liquid | Water | Water | Water |
| Coagulation liquid temperature [° C.] | 30 | 30 | 30 |
| Free running distance [mm] | 120 | 120 | 120 |
| Fine pore diameter [nm] | 200 | 100 | 500 |
| Fine pore structure | Spherulite structure | Spherulite structure | 3 dimensional networks |
| Surface opening ratio [%] | 20 | 20 | 30 |
| Water permeability [L/(m² · h)] | 1,500 | 2,000 | 4,000 |
| Outer diameter/inner diameter [mm] | 1.2/0.7 | 1.2/0.7 | 1.2/0.7 |
| Tensile elongation at break [%] | 30 | 40 | 170 |
| Tensile modulus of elasticity [MPa] | 150 | 150 | 90 |
| Proportion of resin portion with 1 um² or less by image analysis 1 | 18 | 45 | 82 |
| Proportion of resin portion with 1 um² or less by image analysis 2 | 17 | 19 | 78 |
| Proportion of resin portion with 1 um² or less by image analysis 3 | 15 | 10 | 77 |
| Proportion of resin portion with 1 um² or less by image analysis 4 | 14 | 13 | 73 |
| Proportion of resin portion with 10 um² or more by image analysis 1 | 63 | 0 | 7 |
| Proportion of resin portion with 10 um² or more by image analysis 2 | 68 | 75 | 8 |
| Proportion of resin portion with 10 um² or more by image analysis 3 | 55 | 85 | 13 |
| Proportion of resin portion with 10 um² or more by image analysis 4 | 75 | 65 | 7 |
| Raw water average turbidity | 3 | 3 | 10 |
| Time conditions for each step | Filtration: 28.5 | Filtration: 28.5 | Filtration: 28.5 |
| | minutes [symbol] | minutes [symbol] | minutes [symbol] |
| | AB/BW: 1 | AB/BW: 1 | AB: 0.5 |
| | minute [symbol] | minute [symbol] | minutes [symbol] |
| | Drain: 0.5 minutes | Drain: 0.5 minutes | BW: 0.5 minutes [symbol] |
| | | | Drain: 0.5 minutes |
| AB flow rate /backwash (BW) flow rate | 5 Nm³/h/4m³/h | 5 Nm³/h/4m³/h | 7 Nm³/h/4m³/h |

### INDUSTRIAL APPLICABILITY

According to the method of filtration of the present invention, the deterioration of the membrane is minimized by using the porous membrane having high percolativity of fine pores in the cross-sectional microstructure thereof, and by selecting the predetermined physical cleaning method, the membrane can be efficiently cleaned without impairing the filtration performance as well as the lifetime can be extended. Therefore, the present invention can be suitably used as a method for filtering a liquid to be filtered using the porous membrane.

1. A method of filtration, comprising:
filtration in which a liquid to be filtered is filtered through a porous membrane module consisted of a resin having a three-dimensional network structure by external pressure filtration;
cleaning an outer surface of the porous membrane by carrying out backwash of passing a cleaning solution through the porous membrane from an inner surface of the membrane, and air bubbling after the filtration; and
discharging the cleaning solution remaining on the outer surface and inside of the porous membrane after the cleaning; and
in SEM images of a membrane cross section in a membrane thickness direction orthogonal to the inner surface of the porous membrane, a total area of a resin portion having an area of 1 μm² or less is 70% or more relative to a total area of the resin portion in each region of a total of four visual fields consisting of a visual field including the inner surface, a visual field including the outer surface of the membrane, and two fields of vision photographed at equal intervals between the these visual fields.

2. A method of filtration, comprising:
filtration in which a liquid to be filtered is filtered through a porous membrane module consisted of a resin having a three-dimensional network structure by external pressure filtration;
cleaning an outer surface of the porous membrane by carrying out backwash of passing a cleaning solution through the porous membrane from an inner surface of the membrane, and air bubbling after the filtration; and
discharging the cleaning solution remaining on the outer surface and inside of the porous membrane after the cleaning; and
in SEM images of a membrane cross section in a membrane thickness direction orthogonal to the inner surface of the porous membrane, a total area of a resin portion having an area of 10 μm² or more is 15% or less relative to a total area of the resin portion in each region of a total of four visual fields consisting of a visual field including the inner surface, a visual field including the outer surface of the membrane, and two fields of vision photographed at equal intervals between the these visual fields.

3. A method of filtration, comprising:
filtration in which a liquid to be filtered is filtered through a porous membrane module consisted of a resin having a three-dimensional structure by external pressure filtration;
cleaning an outer surface of the porous membrane by carrying out backwash of passing a cleaning solution through the porous membrane from an inner surface of the membrane, and air bubbling after the filtration; and
discharging the cleaning solution remaining on the outer surface and inside of the porous membrane after the cleaning; and
in SEM images of a membrane cross section in a membrane thickness direction orthogonal to the inner surface of the porous membrane, a total area of a resin portion having an area of 1 μm² or less is 70% or more relative to a total area of the resin portion and a total area of a resin portion having an area of 10 μm² or more is 15% or less relative to the total area of the resin portion in each region of a total of four visual fields consisting of a visual field including the inner surface, a visual field including the outer surface of the membrane, and two fields of vision photographed at equal intervals between the these visual fields.

4. The method of filtration according to claim 1, wherein the porous membrane module has an effective membrane length of 1.5 m or more.

5. The method of filtration according to claim 1, wherein the cleaning is carried out after a water permeability of the porous membrane module in the filtration step is decreased to 70% or less of an initial value.

6. The method of filtration according to claim 5, wherein a chemical solution cleaning is carried out when a water permeability of the porous membrane module in the filtration is reduced to 70% or less of an initial value.

7. The method of filtration according to claim 6, wherein the chemical solution cleaning is carried out before or after the cleaning.

8. The method of filtration according to claim 6, wherein the chemical solution cleaning is the cleaning.

9. The method of filtration according to claim 5, wherein the cleaning is carried out after a water permeability of the porous membrane module in the filtration is reduced to 50% or less of an initial value.

10. The method of filtration according to claim 5, wherein a water permeability of a porous membrane module at nth cycle is 80% or more of a water permeability at n−1th cycle when a series of the filtration, the cleaning, and the discharging is one cycle.

11. The method of filtration according to claim 6, wherein a water permeability of the porous membrane module after the chemical solution cleaning after an elapse of 20,000 cycles is 80% or more of an initial value.

12. The method of filtration according to claim 1, wherein a flux of backwash in the cleaning is 1 to 3 times a flux in the filtration.

13. The method of filtration according to claim 6, wherein a chemical solution cleaning is carried out at a specific number of times, and the chemical solution contains an aqueous sodium hydroxide solution.

14. The method of filtration according to claim 6, wherein a chemical solution cleaning is carried out at a specific number of times, and the chemical solution contains an oxidizing agent.

15. The method of filtration according to claim 1, wherein a cleaning at a specific number of times is a chemical solution cleaning, and an oxidizing agent is added to a backwash solution upon backwash in the chemical solution cleaning.

16. The method of filtration according to claim 14, wherein a standard electrode potential of the oxidizing agent is 1 V or more.

17. The method of filtration according to claim 16, wherein a standard electrode potential of the oxidizing agent is 1.8 V or more.

18. The method of filtration according to claim 1, wherein in the discharging, a cleaning solution is discharged from a lower part of the module.

19. The method of filtration according to claim 18, wherein discharge of a cleaning solution from a lower part of the module is carried out by pushing pressurized air from a side nozzle of the module.

20. The method of filtration according to claim 19, wherein a pressure of the pressurized air is 0.2 MPa or less.

21. The method of filtration according to claim 20, wherein a module weight after the discharging is three times or less an initial dry weight of the module.

22. The method of filtration according to claim 1, wherein the porous membrane has a breakage ratio of 0.5% or less after an elapse of 20,000 cycles.

23. The method of filtration according to claim 1, wherein a resin constituting the porous membrane is a thermoplastic resin.

24. The method of filtration according to claim 23, wherein the thermoplastic resin is a fluororesin.

25. The method of filtration according to claim 24, wherein the fluororesin is at least one resin selected from a group consisting of a vinylidene fluoride resin (PVDF), a chlorotrifluoroethylene resin, a tetrafluoroethylene resin, an ethylene-tetrafluoroethylene copolymer (ETFE), an ethylene-monochlorotrifluoroethylene copolymer (ECTFE), a hexafluoropropylene resin and any mixture of these resins.
